(19) United States
(12) Patent Application Publication
(10) Pub. No.: US 2022/0232100 A1
(43) Pub. Date: Jul. 21, 2022

(54) FLEXIBLE PROVISIONING OF NETWORK SLICES IN A MOBILE NETWORK THROUGH A NETWORK EXPOSURE FUNCTION (NEF)

(71) Applicant: eBOS Technologies, Nicosia (CY)

(72) Inventors: Loizos Christofi, Nicosia (CY); Stelios Christofi, Nicosia (CY); Fanos Christofi, Nicosia (CY)

(73) Assignee: eBOS Technologies, Nicosia (CY)

(21) Appl. No.: 17/579,664

(22) Filed: Jan. 20, 2022

(30) Foreign Application Priority Data
Jan. 20, 2021 (FR) FR2100521

(51) Int. Cl. H04L 67/00; H04L 67/10; H04W 4/50

(52) U.S. Cl. CPC H04L 67/34; H04W 4/50; H04L 67/10

(57) ABSTRACT

Embodiments of the present invention provide a method, system and computer program product for flexible provisioning of network resources through a network exposure function (NEF) of a software defined network (SDN) architected mobile communications network. In a flexible provisioning method different instances of correspondingly different virtual network functions (VNFs) are instantiated in a control plane of the SDN and selected ones collected in respectively different collections of a collections pool within the control plane of the SDN. Subsequent to the instantiation, a request by a mobile application can be received in the NEF to access functionality of at least one of the VNFs. In response, one of the different collections of the pool may be selected for assignment to the requesting mobile application and the selected one of the collections then may be assigned to the mobile application through the NEF.

### CROSS REFERENCE TO RELATED APPLICATIONS

This application claims priority under 35 U.S.C. § 119(a) to French patent application FR2100521 filed on Jan. 20, 2021, the entire teachings of which are incorporated herein by reference.

### BACKGROUND OF THE INVENTION

### Field of the Invention

The present invention relates to the field of network resource allocation in a communications network and more particularly to network slice provisioning through an NEF.

### Description of the Related Art

The software defined network (SDN) is a technology that separates the control plane management of different connected network devices, from the underlying data plane that forwards network traffic to the devices. In this regard, an SDN architecture features software-defined controllers abstracted from the underlying network hardware, while offering intent-based or policy-based management of the network as a whole. This results in a network that is better aligned with the needs of application workloads through automated provisioning, programmatic network management, pervasive application-oriented visibility, and where needed, direct integration with cloud orchestration platforms.

The separation of the control from the data plane in a network architecture remains the paramount feature of the SDN. Yet, SDN is more in that the SDN has a centralized or distributed intelligent entity that enjoys an entire view of the network, so as to make routing and switching decisions based on that view. In comparison, legacy network routers and switches only know about neighboring network gear. However, with a properly configured SDN environment, that central entity can control everything, from easily changing policies to simplifying configuration and automation across the enterprise. As can be seen, the principle of the SDN can find wide applications not just in connection with the management of a computer communications network, but also in the implementation and management of a cellular telecommunications network incorporating a computer communications network. As to the latter, the SDN forms an integral part in the emerging next generation cellular telephony space.

Some have referred to network slicing as the “key ingredient” of next generation cellular telephony, enabling the full potential of the next generation architecture to be realized. Network slicing adds an extra dimension to the resource allocation domain by allowing multiple logical networks to simultaneously run on top of a shared physical network infrastructure. As such, network slicing becomes integral to the next generation architecture by creating end-to-end virtual networks that include both networking and storage functions. Operators of a next generation telecommunications network then can effectively manage diverse use cases with differing throughput, latency and availability demands by partitioning network resources to multiple users or “tenants”.

With strategically tuned network slicing and the optimized allocation of resources, known as “virtual network function” (VNF) instances, the cost of operating an SDN architected network can be optimized. Presently, the allocation of VNF instances within particular network slices is based upon pre-provisioning and static configuration without allowing external applications or services to interact with network functions. For example, current mobile network cores include network functions, such as the Network Slice Selection Function and the Policy Control Function, to deploy and manage network slices upon request of the mobile devices' assignment by the mobile operator. However, the management of network resources are statically allocated by the operator to the different slices. Thus, the mobile operator will determine in advance what are the available network slices based on existing resources and will define which users will be allowed to request any of the pre-existing slices. Therefore, there is no possibility to dynamically rearrange the available network slices based on available static network resources.

### BRIEF SUMMARY OF THE INVENTION

Embodiments of the present invention address deficiencies of the art in respect to resource provisioning in an SDN and provide a novel and non-obvious method, system and computer program product for flexible provisioning of network resources through an NEF of an SDN architected mobile communications network. In an embodiment of the invention, a flexible provisioning method includes instantiating different instances of correspondingly different VNFs of a control plane of the SDN and collecting selected ones of the different instances in respectively different collections of a collections pool within the control plane of the SDN. Subsequent to the instantiation, a request by a mobile application can be received in the NEF to access functionality of at least one of the VNFs. In response, one of the different collections of the pool may be selected for assignment to the requesting mobile application and the selected one of the collections then may be assigned to the mobile application through the NEF. In this way, the pool can be defined with an appropriate mix of VFN instances from a posture within the control plane while maintaining a secure barrier between the mobile application and the VFN instances of the control plane prior to deployment of the mobile application into a selected network slice and without adding additional resource burdens upon the control plane.

In one aspect of the embodiment, the pool subsists across a multiplicity of different network slices in the control plane of the mobile communications network. Consequently, each of the different collections of VNF instances are placed into a corresponding one of the different network slices. As such, the assignment includes assigning to the mobile application the corresponding one of the network slices into which the one of the collections had been placed so as to provide access by the mobile application to the VNF instances co-located therein.

In another aspect of the embodiment, additional collections of VNF instances may be added into the pool without assigning any one of the additional collections to any mobile application. Conversely, one of the collections already present in the pool but not yet assigned to any mobile application may be removed from the pool. In even yet another aspect of the embodiment, the mobile application may be characterized according to a general application class and an unassigned one of the collections located in a correlation table in which the unassigned one of the collections has been associated with the general application class. Thereafter, the NEF may assign to the mobile application the unassigned one of the collections of VNF instances.

In another embodiment of the invention, a data processing system can be adapted for flexible provisioning of resources of a mobile communications network. The system includes a host computing platform disposed within a CU of a cellular communications network. While the CU includes a communicative coupling to a multiplicity of different DUs, at least one of which includes a MIMO antenna transmitting over millimeter wave frequencies, the platform includes one or more computers, each with memory and at least one processor, and an SDN established in the platform. Finally, the system includes a network controller disposed within a control plane of the SDN.

The network controller includes computer program instructions enabled while executing in the host computing platform to instantiate different collections of VNFs in a pool of collections within a control plane of the SDN. The program instructions further are enabled to receive in an NEF, subsequent to the instantiation, a request by the mobile application to access different ones of the VNFs. Finally, the program instructions are enabled to respond to the request by assigning through the NEF to the mobile application, one of the instantiated different collections of VNFs in the pool.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is pictorial illustration of a process for flexible provisioning of network resources through an NEF of an SDN architected mobile communications network;

FIG. 2 is a schematic diagram of an SDN architected mobile communications network adapted for flexible provisioning of network resources through an NEF of the SDN architected mobile communications network; and,

FIG. 3 is a flow chart illustrating a process for flexible provisioning of network resources through an NEF of an SDN architected mobile communications network.

### DETAILED DESCRIPTION OF THE INVENTION

Embodiments of the invention provide for flexible provisioning of network resources through an NEF of an SDN architected mobile communications network. In accordance with an embodiment of the invention, different VNFs are instantiated into different collections of VNF instances and the collections are then pooled together into a collections pool across different network slices of a control plane of an SDN defined mobile communications network. Thereafter, subsequent to the creation of the pool, in response to a mobile application invoking an NEF of the control, the mobile application is assigned to one of the collections in the pool so as to have access to all of the VNF instances instantiated as part of the collection. As such, the mobile application can enjoy the simplicity of invoking the NEF without the restriction of the security requirements of the control plane and without the burden of optimizing the collection of VNF instances to be assigned to the mobile application, that burden having been born by the NEF in selecting an optimal arrangement of the VNF instances for the collection in the pool.

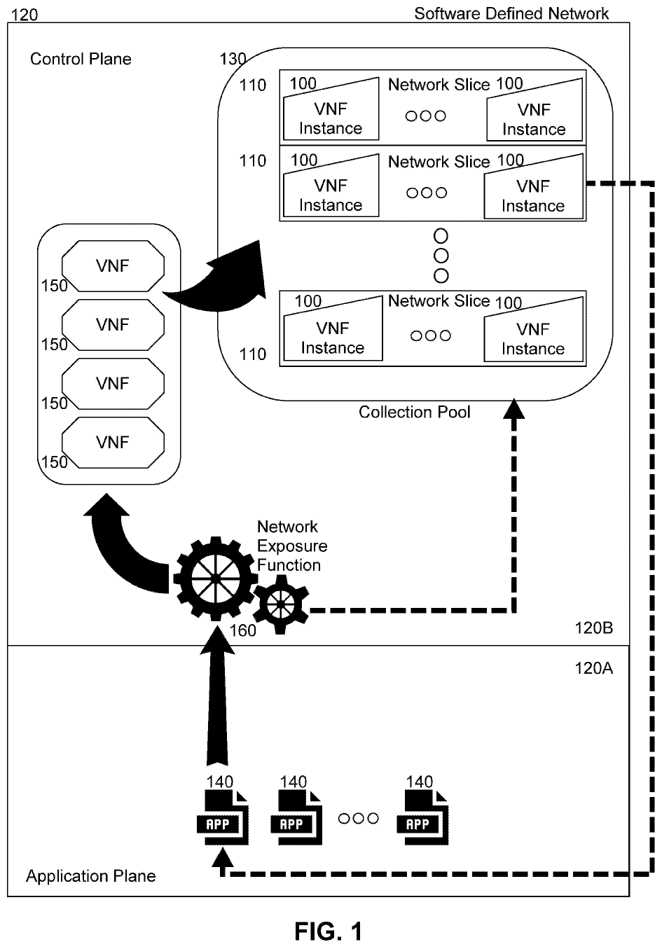

In further illustration, FIG. 1 pictorially shows a process for flexible provisioning of network resources through an NEF of an SDN architected mobile communications network. As shown in FIG. 1 an NEF 160 in the control plane 120B of an SDN 120 creates different VNF instances 100 of corresponding VNFs 150 of the control plane 120B and selects different ones of the VNF instances 100 for grouping in a corresponding collection 110, each of the collections 110 then being placed in a collections pool 130. Optionally, the collections pool 130 of each of the collections 110 can then be organized across a number of different network slices defined in the control plane 120B so that the assignment of any one of the network slices to a corresponding one of a multiplicity of different mobile applications 140 results in the corresponding one of the multiplicity of different mobile applications 140 accessing the VNF instances 100 placed therein.

Thereafter, the NEF 160 receives a request from a requesting one of a number of mobile applications 140 in an application plane 120A of the SDN 120 to access the functionality of one or more of the VNFs 150. In response, the NEF 160 assigns one of the collections 110 to the requesting one of the mobile applications 140. In this regard, in one aspect of the embodiment, the NEF 160 can classify a generalized type of the requesting one of the mobile applications 140 and can locate a corresponding one of the collections 110 associated with the generalized type. As such, the located one of the corresponding one of the collections 110 is then assigned to the requesting one of the mobile applications 140.

As can be seen, the NEF 160 dynamically builds the collections 110 from the instantiated instances 100 of different ones of the VNFs 150 so that the collections 110 of the collection pool 130 can be dynamically assigned to requesting ones of the mobile applications 140. As such, the NEF 160 can actively manage the collections pool 130 to ensure that an optimal number of collections 110 with an optimal mix of VNF instances 100 are placed therein. Consequently, the NEF 160 can dynamically augment the collections pool 130 with new collections 110 with new instances 100 of corresponding ones of the VNFs 150, and the NEF 160 can remove unassigned ones of the collections 110 from the collections pool 130.

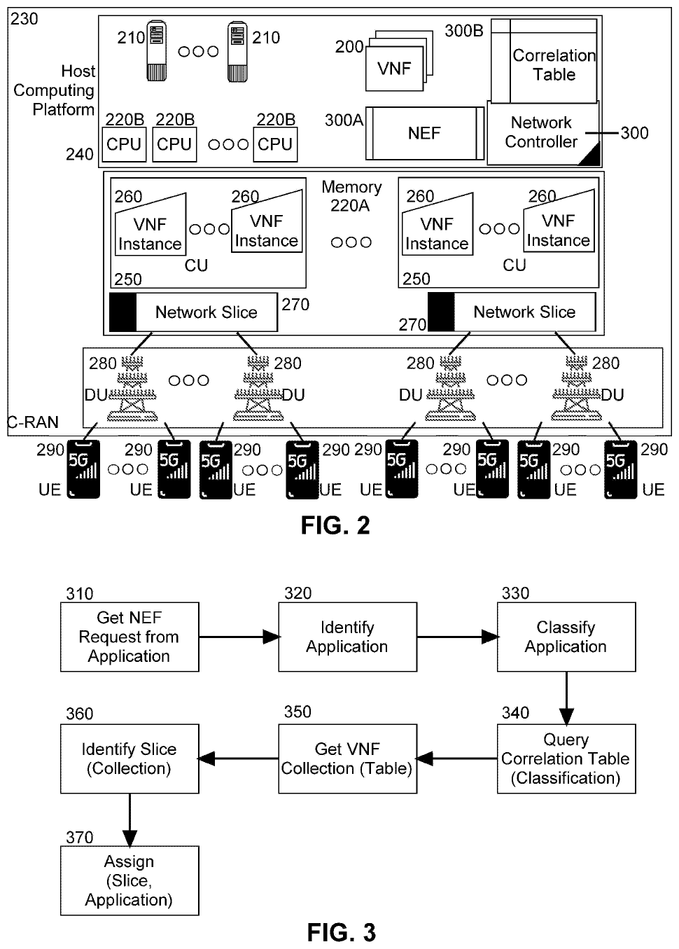

The process described in connection with FIG. 1 may be specifically embodied in an SDN architected telecommunications network. In further illustration, FIG. 2 schematically shows an SDN architected mobile communications network adapted for flexible provisioning of network resources through an NEF of the SDN architected mobile communications network. The system includes a C-RAN 230 implemented in the control plane of an SDN. The C-RAN 230 includes a host computing platform 240 that includes one or more computers 210 each with memory 220A and one or more processors 220B. Multiple different centralized units (CUs) 250 for respective network slices 270 are defined in the memory 220A, each including one or more infrastructure resources 200, namely virtual network functions (VNFs), accessible by different mobile applications executing in an application plane of the SDN (not shown) in order to support processing of mobile cellular network connections with different user equipment (UE) 290 through distributed units (DUs) 280.

Importantly, a network controller 300 is included in the host computing platform 240 and executes by at least one of the processors 220B of the host computing platform 240. The network controller 300 includes computer program instructions that when executing by one or more of the processors 220B, is enabled to instantiate a set of VNF instances 260 for VNFs 200 defined in the host computing platform 240 and to group different ones of the VNF instances 260 into different collections within different CUs 250 of different network slices 270. The program code further is enabled to define a correlation table 300B associating different ones of the collections in the different slices 270 with different generalized application types. The program code yet further is enabled to process a received invocation of an NEF 300 by a mobile application (not shown) by classifying the mobile application, locating in the correlation table 300B a specified one of the collections for the classification of the mobile application, and assigning the slice 270 corresponding to the specified one of the collections to the mobile application.

In yet further illustration of the operation of the network controller 300, FIG. 3 is a flow chart illustrating a process for flexible provisioning of network resources through an NEF of an SDN architected mobile communications network. Beginning in block 310, an NEF request is received from the application and in block 320, the application is identified. Then, in block 330, the application is classified based upon the identification and in block 340, a designated VNF collection is determined for the application based upon the classification. As well, in block 360 a corresponding network slice holding the designated collection is identified and in block 370, the identified network slice is assigned to the application.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network. The computer readable program instructions may execute entirely on the user's computer, partly on the user's computer, as a stand-alone software package, partly on the user's computer and partly on a remote computer or entirely on the remote computer or server. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “include”, “includes”, and/or “including,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A flexible provisioning method of network resources through a network exposure function (NEF) of a software defined network (SDN) architected mobile communications network, the method comprising:
instantiating different instances of correspondingly different virtual network functions (VNFs) of a control plane of the SDN;
collecting selected ones of the different instances in respectively different collections of a collections pool within the control plane of the SDN;
subsequent to the instantiation, receiving in the NEF a request by the mobile application to access functionality of at least one of the VNFs; and, responding to the request by assigning to the mobile application through the NEF, one of the different collections of the pool.

2. The method of claim 1, wherein the collections pool subsists across a multiplicity of different network slices in the control plane such that each of the instances of the VNFs of a corresponding one of the collections are instantiated into a corresponding one of the different network slices and wherein the assignment comprises deploying the mobile application into the corresponding one of the network slices into which the one of the instances of the VNFs for the assigned one of the different collections had been instantiated.

3. The method of claim 1, further comprising adding additional collections of VNF instances into the pool without assigning ones of the additional collections to any mobile application.

4. The method of claim 1, further comprising removing from the pool, one of the collections not contemporaneously assigned to any mobile application.

5. The method of claim 1, further comprising:
characterizing the mobile application according to a general application class;
locating within a correlation table an unassigned one of the collections of VNF instances in the pool that has been associated with the general application class; and,
assigning through the NEF to the mobile application, the unassigned on of the collections of VNF instances.

6. A data processing system adapted for flexible provisioning of resources of a mobile communications network, the system comprising:
a host computing platform disposed within a central unit (CU) of a cellular communications network, the CU comprising a communicative coupling to a multiplicity of different distributed units (DUs), at least one of the DUs comprising a massive multiple input, multiple output (MIMO) antenna transmitting over millimeter wave frequencies, the platform comprising one or more computers, each comprising memory and at least one processor; and,
an SDN established in the host computing platform; and,
a network controller disposed within a control plane of the SDN and comprising computer program instructions enabled while executing in the host computing platform to perform:
instantiating different instances of correspondingly different virtual network functions (VNFs) of the control plane of the SDN;
collecting selected ones of the different instances in respectively different collections of a collections pool within the control plane of the SDN;
subsequent to the instantiation, receiving in the NEF a request by the mobile application to access functionality of at least one of the VNFs; and,
responding to the request by assigning to the mobile application through the NEF, one of the different collections of the pool.

7. The system of claim 6, wherein the collections pool subsists across a multiplicity of different network slices in the control plane such that each of the instances of the VNFs of a corresponding one of the collections are instantiated into a corresponding one of the different network slices and wherein the assignment comprises deploying the mobile application into the corresponding one of the network slices into which the one of the instances of the VNFs for the assigned one of the different collections had been instantiated.

8. The system of claim 6, wherein the program instructions further perform adding additional collections of VNF instances into the pool without assigning ones of the additional collections to any mobile application.

9. The system of claim 6, wherein the program instructions further perform removing from the pool, one of the collections not contemporaneously assigned to any mobile application.

10. The system of claim 6, wherein the program instructions further perform:
characterizing the mobile application according to a general application class;
locating within a correlation table an unassigned one of the collections of VNF instances in the pool that has been associated with the general application class; and,
assigning through the NEF to the mobile application, the unassigned on of the collections of VNF instances.

11. A computer program product for flexible provisioning of resources through a network exposure function (NEF) of a software defined network (SDN) architected mobile communications network, the computer program product including a computer readable storage medium having program instructions embodied therewith, the program instructions executable by a device to cause the device to perform a method including:
instantiating different instances of correspondingly different virtual network functions (VNFs) of a control plane of the SDN;
collecting selected ones of the different instances in respectively different collections of a collections pool within the control plane of the SDN;
subsequent to the instantiation, receiving in the NEF a request by the mobile application to access functionality of at least one of the VNFs; and,
responding to the request by assigning to the mobile application through the NEF, one of the different collections of the pool.

12. The computer program product of claim 11, wherein the collections pool subsists across a multiplicity of different network slices in the control plane such that each of the instances of the VNFs of a corresponding one of the collections are instantiated into a corresponding one of the different network slices and wherein the assignment comprises deploying the mobile application into the corresponding one of the network slices into which the one of the instances of the VNFs for the assigned one of the different collections had been instantiated.

13. The computer program product of claim 11, wherein the method further includes adding additional collections of VNF instances into the pool without assigning ones of the additional collections to any mobile application.

14. The computer program product of claim 11, wherein the method further includes removing from the pool, one of the collections not contemporaneously assigned to any mobile application.

15. The computer program product of claim 11, wherein the method further includes:
characterizing the mobile application according to a general application class;
locating within a correlation table an unassigned one of the collections of VNF instances in the pool that has been associated with the general application class; and,
assigning through the NEF to the mobile application, the unassigned on of the collections of VNF instances.
